(19) United States
(12) Patent Application Publication
(10) Pub. No.: US 2020/0201231 A1
(43) Pub. Date: Jun. 25, 2020

(54) SHEET FEEDER AND IMAGE FORMING APPARATUS

(71) Applicant: TOSHIBA TEC KABUSHIKI KAISHA, Tokyo (JP)

(72) Inventor: Masahiro OHNO, Yokohama Kanagawa (JP)

(73) Assignee: TOSHIBA TEC KABUSHIKI KAISHA, Tokyo (JP)

(21) Appl. No.: 16/225,008

(22) Filed: Dec. 19, 2018

(51) Int. Cl. G03G 15/00; H04N 1/00

(52) U.S. Cl. CPC G03G 15/6511; H04N 1/00708; H04N 1/0066; G03G 15/6558

(57) ABSTRACT

A sheet feeder and an image forming apparatus comprises a sheet feed cassette, in which a sheet bundle formed by stacking a plurality of sheets can be placed, configured to carry out sheets of the placed sheet bundle one by one, and an alignment cassette, in which the sheets carried out from the sheet feed cassette can be placed in a stacked manner one by one, configured to align the stacked sheets at a predetermined timing.

### FIELD

At least one embodiment described herein relate generally to a sheet feeder and an image forming apparatus.

### BACKGROUND

An image forming apparatus forms an image on a sheet while conveying a sheet-like image receiving medium such as a paper (hereinafter, collectively referred to as a “sheet”). The image forming apparatus includes a sheet feeder. For example, the sheet feeder has a plurality of sheet feed cassettes in response to sizes of the sheets. The sheet feed cassettes can replenish a bundle of sheets (sheet bundle) having suitable sizes.

The sheet bundle is distributed in units of hundreds of sheets. The sheet bundle is packaged by some kind of package material such as a wrapping paper to be distributed. The sheet bundle is removed from the package material and set (replenished) in the sheet feed cassette. At that time, in the sheet bundle, the stack of the sheets may collapse (the sheets are deviated along front and back surfaces thereof) in some cases.

The sheet feed cassette has side guides and end guides for aligning the sheet bundle. However, the sheet feed cassette is difficult to align the sheets contained in the sheet bundle in a state in which hundreds of sheets are stacked. If the sheet in the sheet feed cassette is not aligned (hereinafter, referred to as a “sheet setting failure”), there are the following possibilities. In the case of the sheet setting failure, there is a possibility that positional misalignment (tip positional misalignment, horizontal shift, inclination, etc.) between the image and the sheet occurs. In the case of the sheet setting failure, there is a possibility that a sheet jam (paper feed mistake, sheet conveyance failure, etc.) occurs.

### DESCRIPTION OF THE DRAWINGS

FIG. 1 is an external perspective view illustrating an example of a configuration of an image forming apparatus according to at least one embodiment;

FIG. 2 is a front view illustrating an example of a configuration of a sheet feeder of the image forming apparatus according to at least one embodiment;

FIG. 3 is a flowchart depicting an example of a processing by a controller of the image forming apparatus according to at least one embodiment; and

FIG. 4 is a front view illustrating a modification of the sheet feeder of the image forming apparatus according to at least one embodiment.

### DETAILED DESCRIPTION

In accordance with an embodiment, a sheet feeder and an image forming apparatus comprises a sheet feed cassette, in which a sheet bundle formed by stacking a plurality of sheets can be placed, configured to carry out sheets of the placed sheet bundle one by one; and an alignment cassette, arranged such that the sheets carried out from the sheet feed cassette can be placed in a stacked manner one by one, and configured to align the stacked sheets at a predetermined timing.

Hereinafter, a sheet feeder 1 and an image forming apparatus 100 of an embodiment are described with reference to the accompanying drawings.

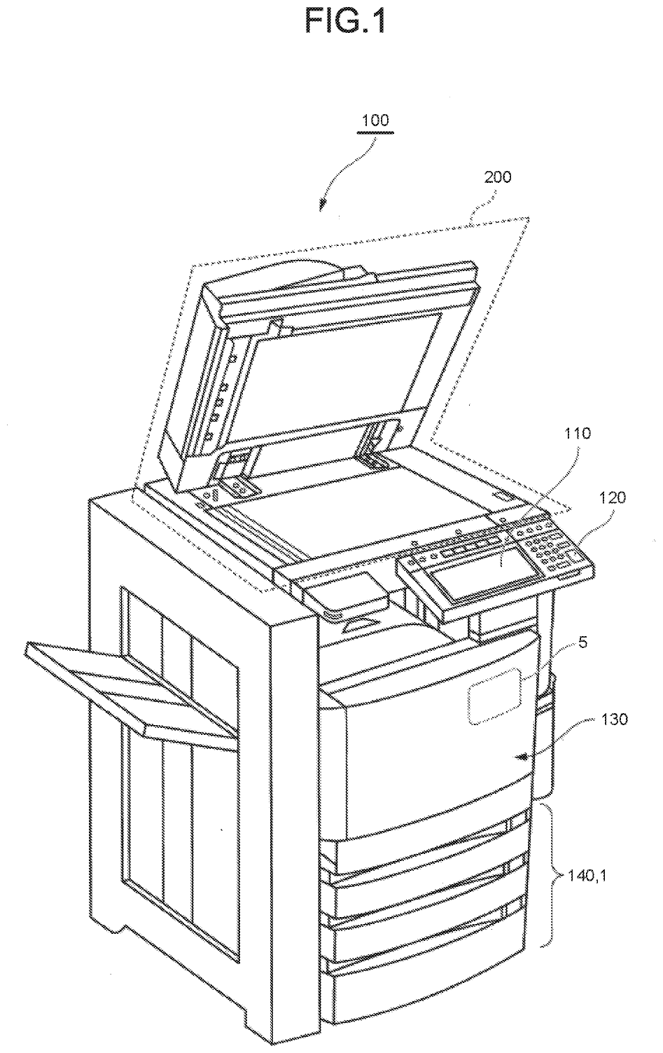

FIG. 1 is an external perspective view of an example of an arrangement of an image forming apparatus 100 according to at least one embodiment. The image forming apparatus 100 is, for example, a MFP (Multifunction Peripheral). The image forming apparatus 100 includes a display 110, a control panel 120, a printer section (image forming section) 130, a sheet housing section (sheet feeder) 140, and an image reading section 200. The printer section 130 of the image forming apparatus 100 may be a device for fixing a toner image or an inkjet type device.

The image forming apparatus 100 forms an image on a sheet with a developer such as a toner. The sheet is, for example, a normal paper or a label paper, or any other medium as long as the image forming apparatus 100 can form an image on the surface of the medium.

The display 110 is an image display device such as a liquid crystal display, an organic EL (Electro Luminescence) display and the like. The display 110 displays various information relating to the image forming apparatus 100.

The control panel 120 includes a plurality of buttons. The control panel 120 receives an operation by a user. The control panel 120 outputs a signal corresponding to an operation carried out by the user to a controller 5 of the image forming apparatus 100. Furthermore, the display 110 and the control panel 120 may be integrated into a single touch panel.

The printer section 130 forms an image on a sheet based on image information generated by the image reading section 200 or image information received via a communication path. The printer section 130 forms the image by, for example, the following processing. An image forming section of the printer section 130 forms an electrostatic latent image on a photoconductive drum based on the image information. The image forming section of the printer section 130 enables a developer to adhere to the electrostatic latent image to form a visible image. Toner is provided as an example of the developer. A transfer section of the printer section 130 transfers the visible image onto the sheet. A fixing section of the printer section 130 heats and pressures the sheet to fix the visible image on the sheet. Furthermore, the sheet on which the image is formed may be a sheet accommodated in the sheet housing section 140 or a manually fed sheet.

The sheet housing section 140 accommodates the sheet used for the image formation by the printer section 130. The sheet housing section 140 conveys the sheet towards the printer section 130. The sheet housing section 140 has a function of aligning replenished sheets. The sheet housing section 140 constitutes the sheet feeder 1 of the embodiment.

The image reading section 200 reads the image information of a read object as intensity of light. The image reading section 200 records the read image information. The recorded image information may be transmitted to another information processing apparatus via a network. The recorded image information may be used for the image formation on the sheet by the printer section 130.

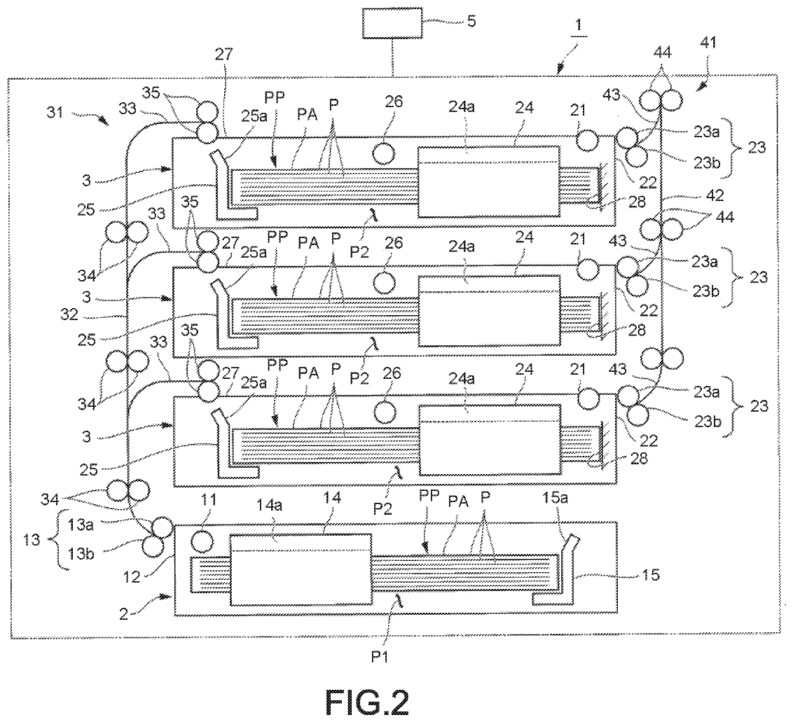

FIG. 2 is a front view illustrating an example of a configuration of the sheet feeder 1 according to at least one embodiment. The sheet feeder 1 includes a sheet feed cassette (sheet feed section) 2 and an alignment cassette (alignment section) 3. The sheet feed cassette 2 and the alignment cassette 3 are substantially horizontal trays, and in each of the sheet feed cassette 2 and the alignment cassette 3, a rectangular sheet P can be placed substantially horizontally. The sheet feed cassette 2 and the alignment cassette 3 are arranged side by side in a vertical direction. For example, a single sheet feed cassette 2 is provided in the lowermost row. For example, a plurality of the alignment cassettes 3 is provided side by side above the sheet feed cassette 2 (the second row or higher row from the bottom). A plurality of the alignment cassettes 3 is provided in response to the sheets P of mutually different sizes.

A sheet bundle PP formed by stacking a plurality of the sheets P can be placed in the sheet feed cassette 2 by being replenished from the outside. A user replenishes the sheet bundle PP, thereby placing the sheet bundle PP in the sheet feed cassette 2.

The sheet feed cassette 2 conveys the sheet P from the right side to the left side of the figure. In the sheet feed cassette 2, the right side of the figure is a conveyance direction upstream side, and the left side of the figure is a conveyance direction downstream side.

On the left side of the sheet feed cassette 2, a pickup roller 11 is provided. The pickup roller 11 is a driving roller. The pickup roller 11 contacts with a sheet PA (hereinafter, referred to as a top sheet PA) at the top of the sheet bundle PP placed in the sheet feed cassette 2 to apply a driving force towards the conveyance direction downstream side. The pickup roller 11 carries the sheets P of the sheet bundle PP placed in the sheet feed cassette 2 out one by one in order from the top sheet PA. On the left side of the pickup roller 11, a carry-out section 12 for carrying the sheet P placed in the sheet feed cassette 2 out is provided.

On the left side of the carry-out section 12, a separation mechanism 13 is provided. The separation mechanism 13 prevents double feeding of the sheet P (conveyance of two or more sheets P in an overlapped state). The separation mechanism 13 includes a sheet feed roller 13a and a separation roller 13b which are opposite to each other in a radial direction. The separation mechanism 13 enables the sheet P carried out from the sheet feed cassette 2 by the pickup roller 11 to pass through a space between the sheet feed roller 13a and the separation roller 13b. For example, the sheet feed roller 13a is a driving roller, and conveys the sheet P at a constant speed with the pickup roller 11. The separation roller 13b is a driven roller that rotates along with the sheet feed roller 13a and has a torque limiter. The separation roller 13b rotates along with the sheet feed roller 13a when the number of sheets P carried out by the pickup roller 11 is one. The separation roller 13b stops rotation to prevent double feeding of the sheet P when the number of sheets P carried out by the pickup roller 11 is two or more. The sheet P carried out from the sheet feed cassette 2 is conveyed by an upstream conveyance device (conveyance module or conveyor) 31 to the alignment cassettes 3 corresponding to a plurality of sheet sizes.

Two opposite sides of the sheet P placed in the sheet feed cassette 2 extends along a conveyance direction.

The sheet feed cassette 2 has a pair of side guides 14 in contact with or close to two sides in the conveyance direction of the placed sheet P (sheet bundle PP). The side guide 14 positions the placed sheet P in a direction (hereinafter, referred to as a sheet width direction) orthogonal to the conveyance direction. The side guide 14 is provided on the downstream side with respect to the center of conveyance direction of the sheet feed cassette 2. Since the side guide 14 is positioned on the downstream side in the conveyance direction, it is possible to guide the sheet P as long as possible when carrying out the sheet P from the sheet feed cassette 2.

The side guide 14 has a slope (inclined surface) 14a which opens to the outside of the sheet width direction at an upper side thereof. When the sheet P is placed in the sheet feed cassette 2, the sheet P moves along the slope 14a in the sheet width direction, thereby aligning both sides in the sheet width direction of the sheet P. For example, the side guide 14 is fixed to the sheet feed cassette 2. For example, the side guide 14 may be movable (or swingable) in the sheet width direction with respect to the sheet feed cassette 2. For example, the side guide 14 may be driven by a driving source to operate to align the sheet P.

The sheet feed cassette 2 has an end guide 15 in contact with or close to one side (hereinafter, referred to as an upstream side) on the conveyance direction upstream side of the placed sheet P (sheet bundle PP). The end guide 15 positions the sheet P to be placed in the conveyance direction. The end guide 15 has a slope (inclined surface) 15a which opens towards the conveyance direction upstream side at the upper side thereof. When the sheet P is placed in the sheet feed cassette 2, the sheet P moves along the slope 15a in the conveyance direction, thereby aligning the conveyance direction upstream side of the sheet P. For example, the end guide 15 is fixed to the sheet feed cassette 2. For example, the end guide 15 may be movable (or swingable) in the conveyance direction with respect to the sheet feed cassette 2. For example, the end guide 15 may be driven by a driving source to operate to align the sheet P.

In the sheet feed cassette 2, a sheet placement space P1 for placing the sheet P (the sheet bundle PP) is partitioned by the side guides 14 and the end guide 15. The sheet P is guided by the side guides 14 and the end guide 15 to the sheet placement space P1. Therefore, at the time of setting the sheet P in the sheet feed cassette 2, it is easy to place the sheet P in the sheet placement space P1.

The sheet placement space P1 corresponds to the maximum sheet size. The maximum sheet size is the maximum size among the sheet sizes corresponding to the alignment cassettes 3. Since the sheet placement space P1 of the sheet feed cassette corresponds to the maximum sheet size, the sheet P, especially those having a small size, can be easily placed in the sheet feed cassette 2. A size of the sheet placement space P1 is larger than the maximum sheet size. Since the size of the sheet placement space P1 of the sheet feed cassette 2 is larger than the maximum sheet size, even the sheet P having the maximum size can be easily placed in the sheet feed cassette 2. Even if the stack of the sheet P collapses when the sheet bundle PP is taken out from the package material, the sheet P can be easily placed in the sheet placement space P1.

The sheet P placed in the sheet feed cassette 2 is conveyed by the upstream conveyance device 31 to the alignment cassette 3 corresponding to the previously assigned sheet size (hereinafter, referred to as a suitable size). Since the sheet P of the maximum size can be placed in the sheet feed cassette 2, the sheet P can be placed in the sheet feed cassette 2 regardless of the sheet size thereof. Since the sheet P can be replenished to the same sheet feed cassette 2 regardless of the sheet size, a sheet setting work becomes easy.

Each alignment cassette 3 can place the sheets P by stacking the sheets P carried out from the sheet feed cassette 2 one by one again. Each alignment cassette 3 aligns the sheets P stacked again at a predetermined timing. The “predetermined timing” in the embodiment refers to at least one timing simultaneously with or immediately after the conveyance of the sheet P. The “predetermined timing” may refer to a timing when each single sheet P is conveyed, or a timing when a plurality of the sheets P is conveyed.

Each alignment cassette 3 conveys the sheet P from the left side to the right side in the figure. In each alignment cassette 3, the left side in the figure is the conveyance direction upstream side, and the right side in the figure is the conveyance direction downstream side. The conveyance direction of the sheet P in each alignment cassette 3 is reversed in the horizontal direction in the figure with respect to the sheet feed cassette 2.

On the right side of each alignment cassette 3, a pickup roller 21 is provided. The pickup roller 21 is a driving roller. The pickup roller 21 carries out the sheets P placed in each alignment cassette 3 one by one from the top sheet PA in order. On the right side of the pickup roller 21, a carry-out section 22 for carrying out the sheet P in each alignment cassette 3 is provided. On the right side of the carry-out section 22, a separation mechanism 23 is provided. The separation mechanism 23 includes a sheet feed roller 23a and a separation roller 23b. The separation mechanism 23 has the same function as the separation mechanism 13 of the sheet feed cassette 2. The sheet P carried out from each alignment cassette 3 is conveyed by a downstream conveyance device 41 to the printer section 130.

In the middle portion in the conveyance direction of each alignment cassette 3, a pull-in roller 26 is provided to pull the sheet P carried in from a carry-in section 27 towards the downstream side. The pull-in roller 26 is a driving roller. The pull-in roller 26 contacts the top sheet PA of the sheets P placed in each alignment cassette 3 to apply a driving force towards the conveyance direction downstream side. The pull-in roller 26 is positioned on the upstream side (the upstream side of the side guide 24) with respect to the center in the conveyance direction of each alignment cassette 3. A stack roller pair 35 of the upstream conveyance device 31 is positioned immediately in front of the carry-in section 27 of each alignment cassette 3. The stack roller pair 35 applies a driving force to the sheet P to sends it to each alignment cassette 3.

Each alignment cassette 3 has mutually identical configuration. Each alignment cassette 3 has a size capable of stacking not only the relatively large sheet P but also the relatively small sheet P. The size of the sheet P carried in each alignment cassette 3 is arbitrarily set in advance. When the relatively small sheet P is carried in the alignment cassette 3, the relatively small sheet P is separated from the stack roller before abutting against a back wall 28. The pull-in roller 26 applies a driving force to the sheet P at the middle portion in the conveyance direction of the alignment cassette 3 to transmit the sheet P until the sheet P abuts against the back wall 28.

The two opposed sides of the sheet P placed in each alignment cassette 3 are along the conveyance direction.

Each alignment cassette 3 has a pair of side guides 24 in contact with or close to the both sides along the conveyance direction of the placed sheet P (sheet bundle PP). The side guide 24 aligns the placed sheet P in the direction orthogonal to the conveyance direction (i.e., the sheet width direction). The side guide 24 is provided on the downstream side with respect to the center in the conveyance direction of each alignment cassette 3. Since the side guide 24 is positioned on the conveyance direction downstream side, it is possible to guide the sheet P as long as possible when the sheet P is carried out from each alignment cassette 3.

The side guide 24 has a slope (inclined surface) 24a which opens to the outside in the sheet width direction at the upper side thereof. The sheet P moves along the slope 24a in the sheet width direction when it is placed in each alignment cassette 3, thereby aligning both sides in the sheet width direction of the sheet P. The side guide 24 is movable (or swingable) in the sheet width direction with respect to each alignment cassette 3. The side guide 24 is driven by a driving source to operate to align the sheet P.

The side guide 24 is a movable alignment guide member that guides the sheet P conveyed by the upstream conveyance device 31 to a sheet alignment space P2. After the sheet P is conveyed to each alignment cassette 3, the sheet feeder 1 operates the alignment guide member to guide the sheet P to the sheet alignment space P2. The alignment guide member retreats from the sheet alignment space P2 at the time of conveying the sheet P. The alignment guide member operates appropriately after the conveyance of the sheet P to align the sheet P. The alignment guide member aligns the conveyed sheet P reliably without hindering the conveyance of the sheet P.

Each alignment cassette 3 has an end guide 25 in contact with or close to one side (hereinafter, referred to as an upstream side) on the conveyance direction upstream side of the placed sheet P (sheet bundle PP). The end guide 25 positions the sheet P to be placed in the conveyance direction. The end guide 25 has a slope (inclined surface) 25a which opens to the conveyance direction upstream side at the upper side thereof. The sheet P moves in the conveyance direction along the slope 25a when it is placed in each alignment cassette 3, thereby aligning the conveyance direction upstream side of the sheet P. For example, the end guide 25 is fixed to the sheet feed cassette 2. For example, the end guide 25 may be movable (or swingable) in the conveyance direction with respect to each alignment cassette 3. For example, the end guide 25 may be driven by a driving source to operate to align the sheet P. The end guide 25 may function as the above-mentioned movable alignment guide member.

On the right side of each alignment cassette 3, there is provided the back wall 28 against which one side (hereinafter, referred to as a downstream side) on the conveyance direction downstream side of the sheet P can abut. The sheet P conveyed by the upstream conveyance device 31 is carried in each alignment cassette 3 from the left side. The sheet P carried in each alignment cassette 3 stops after the downstream side of the sheet P abuts against the back wall 28. The sheets P, which abut against the back wall 28 and stop, are sequentially stacked by natural drop (or biased downwards by a pressing member). The back wall 28 has a function of positioning the sheet P in the conveyance direction. The sheet P positioned by the back wall 28 in the conveyance direction is positioned in the sheet width direction by the operation of the side guide 24. The upstream side of the sheet P is positioned by the end guide 25.

In each alignment cassette 3, the sheet alignment space P2 is partitioned by the side guide 24, the end guide 25 and the back wall 28. The sheet alignment space P2 corresponds to the sheet size suitable for each alignment cassette 3. Each alignment cassette 3 guides the sheet P reliably in the sheet alignment space P2 with the side guide 24, the end guide 25 and the back wall 28. Each alignment cassette 3 aligns the sheet P in the sheet alignment space P2.

On the conveyance direction upstream side of the plurality of the alignment cassettes 3, the upstream conveyance device 31 for conveying the sheet P carried out from the sheet feed cassette 2 to each alignment cassette 3 is provided. The upstream conveyance device 31 includes a main conveyance route 32 extending in the vertical direction, a plurality of divergent conveyance routes 33 branched from the main conveyance route 32 and extending towards the carry-in section 27 of each alignment cassette 3, conveyance roller pairs 34 provided on the conveyance direction upstream side of each alignment cassette 3 at the main conveyance route 32, and stack roller pairs 35 provided at the tip of each divergent conveyance route 33. At the lower end of the main conveyance route 32, the separation mechanism 13 is arranged.

Each conveyance roller pair 34 includes a driving roller. Each conveyance roller pair 34 conveys the sheet P upwards along the main conveyance route 32.

Each stack roller pair 35 includes a driving roller. Each stack roller pair 35 is disposed immediately in front of the carry-in section 27 of the alignment cassette 3. Each stack roller pair 35 carries the sheet P sent from the main conveyance route 32 to the corresponding divergent conveyance route 33 in the corresponding alignment cassette 3. At a base end of each divergent conveyance route 33, a branch mechanism (not shown) for guiding the sheet P from the main conveyance route 32 is provided.

The upstream conveyance device 31 operates under the control of the controller 5. The controller 5 controls the operation of the upstream conveyance device 31 according to “sheet size information” of the sheet P placed in the sheet feed cassette 2. Depending on the sheet size information, the upstream conveyance device 31 can convey the sheet P carried out from the sheet feed cassette 2 to the alignment cassette 3 having the suitable size. The sheet feeder 1 can distribute the sheets P having plural sheet sizes to the alignment cassettes 3 having the suitable sizes, thereby improving convenience.

For example, the “sheet size information” is obtained from a sensor in the sheet feed cassette 2. The sensor is a sheet size detection device that detects the sheet size of the sheet P placed in the sheet feed cassette 2. The upstream conveyance device 31 conveys the sheet P according to the sheet size information obtained from the sheet size detection device. The upstream conveyance device 31 conveys the sheets P having a plurality of the sheet sizes to the alignment cassettes 3 having the suitable sizes. The sheet feeder 1 can automatically distribute the sheets P having a plurality of the sheet sizes to the alignment cassettes 3 having the suitable sizes, which further improves the convenience. For example, the sheet size may be detected from a position of at least one of the movable side guide 24 and the end guide 25.

For example, the “sheet size information” may be obtained from information input to the control panel 120. The control panel 120 is a device for inputting the sheet size of the sheet P placed in the sheet feed cassette 2. The sheet size can be input in the control panel 120 through an external operation by a user (user operation). The upstream conveyance device 31 conveys the sheet P according to the sheet size information obtained from the operation by the user. The upstream conveyance device 31 conveys the sheets P having a plurality of the sheet sizes to the alignment cassettes 3 having the suitable sizes. The sheet feeder 1 can distribute the sheets P having a plurality of the sheet sizes to the alignment cassettes 3 having the suitable sizes (or alignment cassettes required by the user), thereby further improving the convenience.

The front and rear surfaces and the conveyance direction of the sheet P carried out from the sheet feed cassette are reversed by the sheet P passing through the main conveyance route 32 and each divergent conveyance route 33. The conveyance mechanism is also a direction inversion mechanism for reversing the front and rear surfaces and the conveyance direction of the sheet P.

The sheets P of the sheet bundle PP placed in the sheet feed cassette 2 are carried out in order from the top sheet PA. The upstream conveyance device 31 reverses the upper and lower surfaces of the sheet P carried out from the sheet feed cassette 2 and conveys the sheet P to the alignment cassette 3. In the alignment cassette 3, the sheets P with the upper and lower surfaces reversed are stacked in order from the bottom.

The sheet bundle PP stacked in the alignment cassette 3 is in a state in which the same paper surfaces as the sheet bundle PP (original sheet bundle PP) placed in the sheet feed cassette 2 contact with each other. A coefficient of friction between the sheet surfaces contacting with each other of the sheet bundle PP stacked in the alignment cassette 3 does not change with respect to the original sheet bundle PP. For this reason, the occurrence of the sheet conveyance failure such as double feeding or the like is not increased for the sheet bundle PP stacked in the alignment cassette 3 when compared with the original sheet bundle PP. If there is a stacking order of the sheets P in the original sheet bundle PP, the stacking order is also maintained for the sheet bundle PP stacked in the alignment cassette 3.

On the conveyance direction downstream side of a plurality of the alignment cassettes 3, the downstream conveyance device 41 for conveying the sheet P carried out from each alignment cassette 3 to the printer section 130 is provided. The downstream conveyance device 41 includes a main conveyance route 42 extending in the vertical direction, a plurality of merged conveyance routes 43 extending immediately behind the carry-out section 22 of each alignment cassette 3 and merging into the main conveyance route 42, and conveyance roller pairs 44 provided on the main conveyance route 42 on the conveyance direction downstream side of each alignment cassette 3. At the base end of each merged conveyance path 43, the separation mechanism 23 is disposed, respectively.

Each conveyance roller pair 44 includes a driving roller. Each conveyance roller pair 44 conveys the sheet P upwards along the main conveyance route 42.

The image forming apparatus 100 can pull the sheet feed cassette 2 out from an apparatus main body. The image forming apparatus 100 enables the replenishment of the sheet bundle PP by the user to the sheet feed cassette 2 pulled out from the apparatus main body. When the user unpacks the sheet bundle PP to replenish (set) it to the sheet feed cassette 2, collapse of the stack of the sheets P may occur. If the stack of the sheets P collapses, it is difficult to align the sheet P only by pressing the sheet bundle PP from a side of the sheet bundle PP. If the sheets P are in a collapsed state (sheet setting failure), a positional misalignment between the image and the sheet P occurs or the sheet jam occurs.

The sheet feeder 1 and the image forming apparatus 100 of the embodiment comprises the alignment cassette 3 for realigning the sheet P in addition to the sheet feed cassette 2 for replenishing the sheet bundle PP. The sheets P of the sheet bundle PP replenished to the sheet feed cassette 2 are conveyed to the alignment cassette 3 one by one from the top sheet PA and are stacked again in the alignment cassette 3. The sheets P stacked in the alignment cassette 3 are realigned at the predetermined timing.

The sheets P of the sheet bundle PP placed in the sheet feed cassette 2 are realigned at the predetermined timing in the process of being conveyed to the alignment cassette 3 to be stacked. Since the sheets P are realigned in the alignment cassette 3, collapse of the overlapping (stack) of the sheets P is permitted in the sheet feed cassette 2. Since the collapse of the sheets P is allowed in the sheet feed cassette 2, it becomes easier to replenish (set) the sheet bundle PP to the sheet feed cassette 2. Since the sheets P are realigned in the alignment cassette 3, no sheet setting failure occurs, and the occurrence of the positional misalignment between the image and the sheet P and occurrence of the sheet jam are prevented.

As described above, according to the sheet feeder 1 and the image forming apparatus 100 of at least one embodiment, it is possible to facilitate the sheet setting job and to prevent troubles due to the sheet setting failure.

The sheet bundle PP from the sheet feed cassette 2 to the alignment cassette 3 is not restricted to being transferred by conveying the sheets P one by one. For example, the sheet bundle PP may be transferred by conveying a plurality of the sheets P at one time or conveying the sheet P to which a binding processing is performed.

The frequency (timing) of the alignment performed in the alignment cassette 3 is not limited to a timing when each single sheet P is conveyed. For example, the alignment may be performed each time a plurality of the sheets P is conveyed. In this case, the time required for transfer of the sheet bundle PP can be reduced. The timing of alignment may be different between the first half and the latter half of the transfer of the sheet bundle PP.

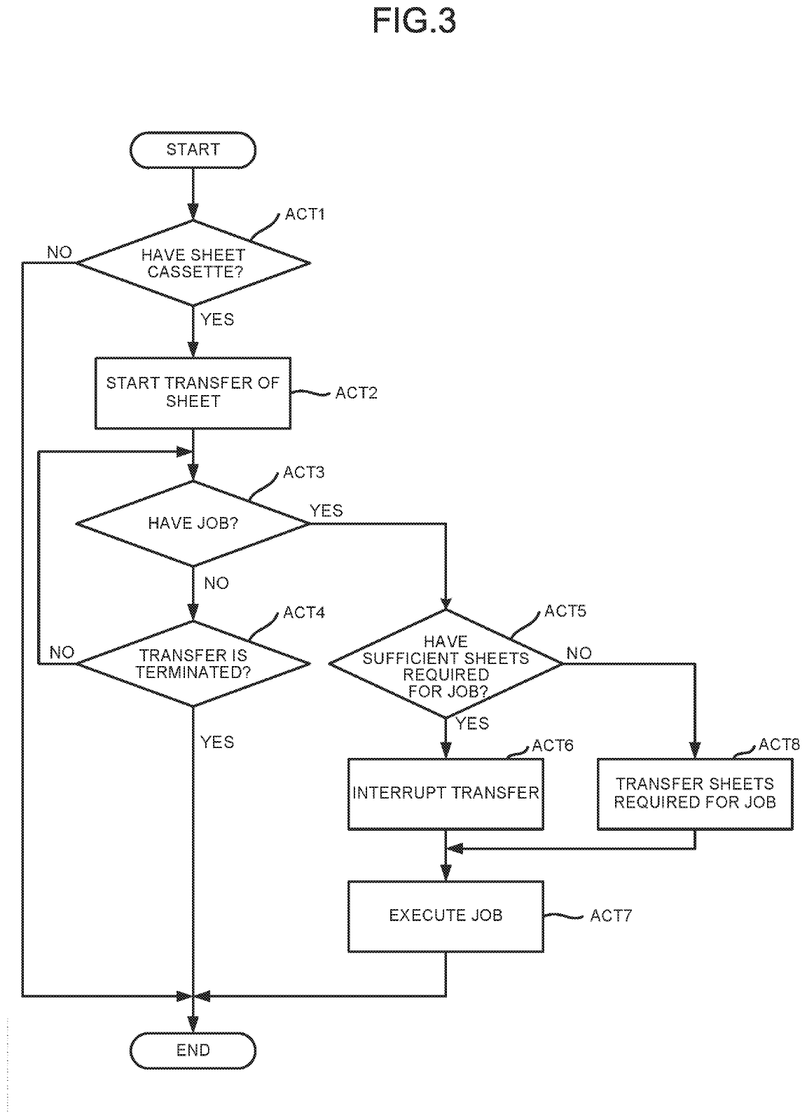

FIG. 3 is a flowchart depicting an example of a processing by the controller 5 of the image forming apparatus 100 according to at least one embodiment.

The controller 5 performs the following processing when a main power supply of the image forming apparatus 100 is turned on.

First, it is determined whether or not the sheet P (the sheet bundle PP) is set in the sheet feed cassette 2 (ACT 1). If no sheet P is set (No in ACT 1), the processing is terminated for the moment. If the sheet P is set (Yes in ACT 1), the flow proceeds to the processing in ACT 2.

In ACT 2, the transfer of the sheet P from the sheet feed cassette 2 to any one of the alignment cassettes 3 is started. At the start of transfer of the sheet P, the upstream conveyance device 31 and each alignment cassette 3 are controlled according to the sheet size information of the sheet P placed in the sheet feed cassette 2. According to the control, the sheet P carried out from the sheet feed cassette 2 is conveyed to the alignment cassette 3 having the suitable size.

After starting the transfer of the sheet P, it is determined whether or not there is a printing request (job command) (ACT 3). If there is no job command (No in ACT 3), then it is determined whether or not the transfer of the sheet P is terminated (ACT 4). If the transfer of the sheet P is terminated (Yes in ACT 4), the processing is terminated for the moment. If the transfer of the sheet P is not terminated (No in ACT 4), the flow returns to the processing in ACT 3.

If there is a job command in ACT 3 (Yes in ACT 3), then it is determined whether or not there are sufficient sheets P required for the job command in the target alignment cassette 3 (ACT 5). If there are the sufficient sheets P required for the job (Yes in ACT 5), the transfer of the sheet P is interrupted (ACT 6). Then, the printing according to the job command is executed (ACT 7).

If there are not the sufficient sheets P required for the job in ACT 5 (No in ACT 5), the flow proceeds to the processing in ACT 8 and the transfer of the sheets P required for the job is continued. Thereafter, the flow proceeds to the processing in ACT 7, and the printing according to the job command is executed.

The sheet P to be replenished to the image forming apparatus 100 is usually distributed as the sheet bundle PP which is in units of several hundreds of sheets. If all sheets of the sheet bundle PP replenished to the sheet feed cassette 2 are continuously transferred to the alignment cassette 3, the transfer waiting time becomes longer. The image forming apparatus 100 of the embodiment interrupts the transfer when there is a job command even at the time of transferring the sheet bundle PP.

The controller 5 controls the sheet feeder 1 and the image forming section to execute the job command when the transfer of the sheet P is interrupted. By stopping the conveyance of the sheet P and executing the job when there is a printing request (job command), the convenience is improved by eliminating the waiting time of the job.

The controller 5 continues to transfer the sheet P until there are the sufficient sheets P required for the printing request in the alignment cassette 3 when there are not the sufficient sheets P required for the printing request in the alignment cassette 3. If the transfer of the sheet P is simply interrupted when there is the job command, there is a case in which there are not the sufficient sheets P required for the job in the alignment cassette 3. If there are not the sufficient sheets P required for the job in the alignment cassette 3 when there is the job command, only the sheets P required for the job are transferred to the alignment cassette 3. Since the transfer of the sheet P is interrupted after the sheets P required for the job are transferred to the alignment cassette 3, the waiting time of the job is reduced and the job can be reliably executed.

The sheet feed cassette 2 is not limited to the lowermost cassette of the sheet feeder 1, and it may be the second or higher cassette. The sheet feed cassette 2 is not limited to a cassette that is pulled in and drawn out of the apparatus main body, and it may be a cassette installed outside the apparatus main body.

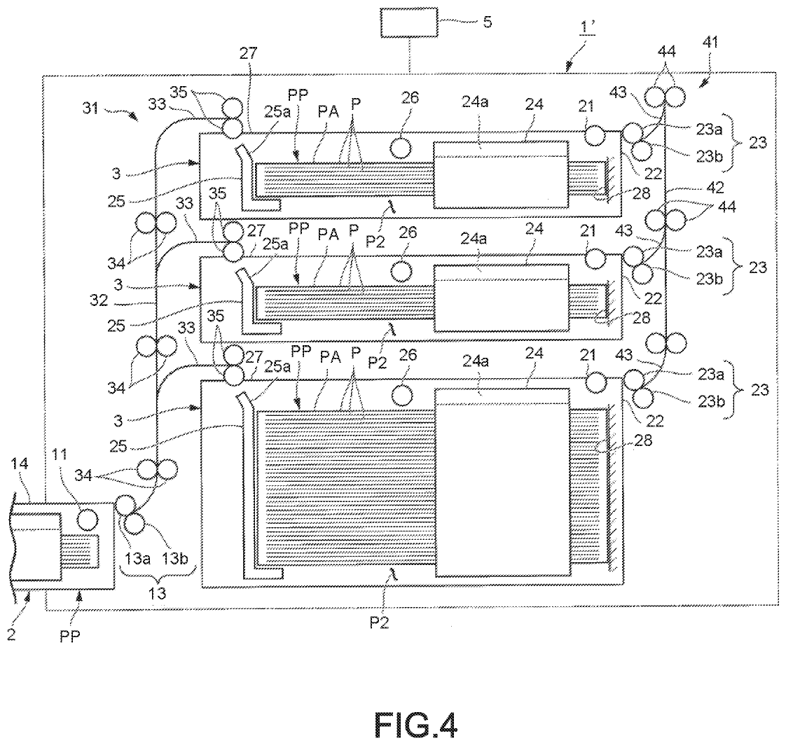

FIG. 4 shows a sheet feeder 1′ according to some embodiments of a modification. The sheet feed cassette 2 can be attached to or removed from the external side of the lower part of the apparatus main body of the sheet feeder 1′. For convenience of illustration, the depth of the alignment cassette 3 at the bottom is increased, but it is not limited thereto.

According to at least one embodiment described above, the sheet feeder 1 and the image forming apparatus 100 has the sheet feed cassette 2 and the alignment cassette 3, thereby facilitate the sheet setting job and preventing troubles due to the sheet setting failure.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sheet feeder, comprising:
a sheet feed cassette, in which a sheet bundle formed by stacking a plurality of sheets can be placed, configured to carry out sheets of the placed sheet bundle one by one; and
an alignment cassette, arranged such that the sheets carried out from the sheet feed cassette can be placed in a stacked manner one by one, and configured to align the stacked sheets at a predetermined timing.

2. The sheet feeder according to claim 1, further comprising:
a conveyor configured to convey a sheet carried out from the sheet feed cassette to the alignment cassette, wherein
the sheet feed cassette carries out the sheets in order from a sheet at the top of the placed sheet bundle, and
the conveyor is configured to reverse upper and lower surfaces of the sheet carried out from the sheet feed cassette and convey the sheet to the alignment cassette.

3. The sheet feeder according to claim 2, wherein the conveyor is configured to convey a plurality of sheets at one time carried out from the sheet feed cassette to the alignment cassette.

4. The sheet feeder according to claim 2, further comprising
a plurality of the alignment cassettes to which sheet sizes are assigned,
wherein the sheet feed cassette is configured to place a sheet having a maximum size among a plurality of the sheet sizes, and
wherein the conveyor is configured convey a sheet carried out from the sheet feed cassette to one of the alignment cassettes to which the corresponding sheet size is assigned.

5. The sheet feeder according to claim 4, wherein the alignment cassettes are arranged directly above the sheet feed cassette.

6. The sheet feeder according to claim 4, wherein some of the alignment cassettes are arranged above the sheet feed cassette and other of the alignment cassettes are arranged below the sheet feed cassette.

7. The sheet feeder according to claim 4, wherein the alignment cassettes have an identical structure.

8. The sheet feeder according to claim 2, further comprising:
a controller configured to control the conveyor according to sheet size information of a sheet placed in the sheet feed cassette to convey the sheet carried out from the sheet feed cassette to the alignment cassette to which the corresponding sheet size is assigned.

9. The sheet feeder according to claim 8, further comprising:
a sheet size detector configured to detect a sheet size of a sheet placed in the sheet feed cassette, wherein
the controller is configured to control the conveyance module according to the sheet size information obtained from the sheet size detector.

10. The sheet feeder according to claim 9, wherein the sheet size detector includes a sensor.

11. The sheet feeder according to claim 8, further comprising:
an input device configured to enable input of a sheet size of a sheet placed in the sheet feed cassette, wherein
the controller is configured to control the conveyor according to the sheet size information input from the input device.

12. The sheet feeder according to claim 2, wherein
the alignment cassette comprises a movable alignment guide member configured to guide the sheet conveyed by the conveyor to a sheet alignment space used for alignment of the sheet.

13. The sheet feeder according to claim 12, wherein
the alignment cassette comprises a back wall that abuts against a downstream end in a conveyance direction of the sheet conveyed by the conveyor, and
the alignment guide member comprises a side guide that guides the sheet abutting against the back wall to the sheet alignment space in a sheet width direction crossing the conveyance direction.

14. The sheet feeder according to claim 13, wherein the side guide includes an inclined surface which opens to an outside of the sheet width direction at an upper side of the of the side guide.

15. An image forming apparatus, comprising:
a sheet feeder;
an image forming section configured to form an image on a sheet supplied from the sheet feeder; and
a controller configured to control the sheet feeder and the image forming section, wherein
the sheet feeder comprises
a sheet feed cassette, in which a sheet bundle formed by stacking a plurality of sheets can be placed, configured to carry out sheets of the placed sheet bundle one by one; and
an alignment cassette, arranged such that the sheets carried out from the sheet feed cassette can be placed in a stacked manner one by one, and configured to align the stacked sheets at a predetermined timing, and
the controller is configured to perform control to transfer a sheet bundle placed in the sheet feed cassette to the alignment cassette, and to perform control to execute a printing request while interrupting the conveyance of the sheet bundle when there is the printing request during the control of the transfer of the sheet bundle.

16. The image forming apparatus according to claim 15, wherein
the controller is configured to continue to transfer the sheet bundle until there are sufficient sheets required for the printing request in the alignment cassette when there are not the sufficient sheets required for the printing request in the alignment cassette when the printing request occurs during the control of the transfer of the sheet bundle.

17. An image forming apparatus, comprising:
a sheet feeder;
an image forming section configured to form an image on a sheet supplied from the sheet feeder; and
a controller configured to control the sheet feeder and the image forming section, wherein
the sheet feeder comprises
a sheet feed cassette, in which a sheet bundle formed by stacking a plurality of sheets can be placed, configured to carry out sheets of the placed sheet bundle one by one; and
an alignment cassette, arranged such that the sheets carried out from the sheet feed cassette can be placed in a stacked manner one by one, and configured to align the stacked sheets at a predetermined timing, and
the controller is configured to perform control to transfer a sheet bundle placed in the sheet feed cassette to the alignment cassette.

18. The image forming apparatus according to claim 17, further comprising:
a conveyor configured to convey a sheet carried out from the sheet feed cassette to the alignment cassette, wherein
the sheet feed cassette carries out the sheets in order from a sheet at the top of the placed sheet bundle,
wherein the conveyor is configured to reverse upper and lower surfaces of the sheet carried out from the sheet feed cassette and convey the sheet to the alignment cassette.

19. The image forming apparatus according to claim 18, further comprising
a plurality of the alignment cassettes to which sheet sizes are assigned,
the sheet feed cassette is configured to place a sheet having a maximum size among a plurality of the sheet sizes, and
the conveyor is configured convey a sheet carried out from the sheet feed cassette to one of the alignment cassettes to which the corresponding sheet size is assigned.
